(19) United States
(12) Patent Application Publication
(10) Pub. No.: US 2007/0176535 A1
(43) Pub. Date: Aug. 2, 2007

(54) LIGHT-EMITTING MATERIAL, LIGHT-EMITTING ELEMENT, LIGHT-EMITTING DEVICE, AND ELECTRONIC APPLIANCE

(75) Inventor: Junichiro SAKATA, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/624,563

(22) Filed: Jan. 18, 2007

(30) Foreign Application Priority Data
Jan. 27, 2006 (JP) 2006-019867

(51) Int. Cl. H01J 1/62

(52) U.S. Cl. 313/503

(57) ABSTRACT

The present invention is to provide a novel light-emitting material, a light-emitting element capable of low-voltage driving, and light-emitting device and electronic appliance with lower power consumption. Moreover, the present invention is to provide light-emitting device and electronic appliance manufactured at low cost. The light-emitting material includes a base material, a first impurity, a second impurity, and a third impurity. The first impurity forms a shallow donor level in the base material, the second impurity forms a shallow acceptor level in the base material, and the third impurity forms a shallow trap level in the base material. The base material includes a compound including an element of Group 2 in the periodic table and an element of Group 16 in the periodic table. Light is emitted by recombination of an electron at the shallow donor level and a hole at the deep trap level.

### TECHNICAL FIELD

The present invention relates to a light-emitting material. Moreover, the present invention relates to a light-emitting element using electroluminescence. Furthermore, the present invention relates to a light-emitting device and an electronic appliance each having a light-emitting element.

### BACKGROUND ART

In recent years, research and development have been extensively conducted on light-emitting elements using electroluminescence. In a basic structure of such a light-emitting element, a substance having a light-emitting property is interposed between a pair of electrodes. By applying voltage to this element, light emission can be obtained from the substance having a light-emitting property.

Since such a light-emitting element is of self-light-emitting type, it is considered that the light-emitting element has advantages over a liquid crystal display in that visibility of pixels is high, backlight is not required, and so on and is therefore suitable for a flat panel display element. In addition, other advantages of such a light-emitting element are that the element can be manufactured to be thin and lightweight and the response speed is very high.

Since the light-emitting element can be formed into a film shape, surface light emission can be easily obtained by forming a large-area element. This is a feature which is difficult to be obtained by point light sources typified by an incandescent lamp and an LED or linear light sources typified by a fluorescent lamp. Accordingly, the light-emitting element is also effectively used as a surface light source applicable to illumination and the like.

Light-emitting elements using electroluminescence are classified broadly according to whether they use an organic compound or an inorganic compound as a substance having a light-emitting property.

It is considered that a light-emitting element using an inorganic compound as a substance having a light-emitting property provides light emission by collisional excitation of a light emission center by an electron accelerated by a high electric field. Therefore, a high electric field was necessary in order to obtain light emission and a voltage of several hundred volts was necessary to be applied to the light-emitting element. Thus, the power consumption was high and burden on the environment was also heavy.

Moreover, in order to apply high voltage to the light-emitting element, a driver circuit with high withstand voltage is necessary. However, formation of a driver circuit with high withstand voltage costs much, causing the price of a product using the light-emitting element to increase.

### DISCLOSURE OF INVENTION

In view of the aforementioned problems, it is an object of the present invention to provide a novel light-emitting material. Moreover, it is an object of the present invention to provide a light-emitting element capable of low-voltage driving. Further, it is an object of the present invention to provide a light-emitting device and an electronic appliance which consume less electric power. In addition, it is an object of the present invention to provide a light-emitting device and an electronic appliance which can be manufactured at low cost.

As a result of concerted studies, the present inventor has found out that the problem can be solved by forming a shallow donor level, a shallow acceptor level, and a deep trap level in a light-emitting material.

Therefore, an aspect of the present invention is a light-emitting material which includes a base material, a first impurity, a second impurity, and a third impurity. The first impurity forms a shallow donor level in the base material, the second impurity forms a shallow acceptor level in the base material, and the third impurity forms a deep trap level in the base material. The base material includes a compound including an element of Group 2 in the periodic table and an element of Group 16 in the periodic table, and light is emitted by recombination of an electron at the shallow donor level and a hole at the deep trap level.

Another aspect of the present invention is a light-emitting material which includes a base material, a first impurity, a second impurity, and a third impurity. The first impurity forms a shallow donor level in the base material, the second impurity forms a shallow acceptor level in the base material, and the third impurity forms a deep trap level in the base material. The base material includes a compound including an element of Group 2 in the periodic table and an element of Group 16 in the periodic table, and light is emitted by recombination of an electron at the deep trap level and a hole at the shallow acceptor level.

Another aspect of the present invention is a light-emitting material which includes a base material, a first impurity, a second impurity, and a third impurity. The first impurity forms a shallow donor level in the base material, the second impurity forms a shallow acceptor level in the base material, and the third impurity forms a deep trap level in the base material. The base material includes a compound including an element of Group 12 in the periodic table and an element of Group 16 in the periodic table, and light is emitted by recombination of an electron at the shallow donor level and a hole at the deep trap level.

Another aspect of the present invention is a light-emitting material which includes a base material, a first impurity, a second impurity, and a third impurity. The first impurity forms a shallow donor level in the base material, the second impurity forms a shallow acceptor level in the base material, and the third impurity forms a deep trap level in the base material. The base material includes a compound including an element of Group 12 in the periodic table and an element of Group 16 in the periodic table, and light is emitted by recombination of an electron at the deep trap level and a hole at the shallow acceptor level.

In the above structure, the energy difference between the shallow donor level and a conduction band of the base material ranges from 0.01 to 0.3 eV.

In the above structure, the energy difference between the shallow acceptor level and a valence band of the base material ranges from 0.01 to 0.3 eV.

In the above structure, the energy difference between the deep trap level and a conduction band or a valence band of the base material is 0.3 eV or more.

An aspect of the present invention is a light-emitting element including the aforementioned light-emitting material between a pair of electrodes.

In the above structure, an insulating layer is preferably provided between the electrode and a light-emitting layer including the light-emitting material. The insulating layer preferably has a thickness of 1 to 500 nm. The insulating layer more preferably has a thickness of 1 to 100 nm.

In the above structure, the insulating layer includes any of yttrium oxide (Y₂O₃), aluminum oxide (Al₂O₃), tantalum oxide (Ta₂O₅), silicon oxide (SiO₂), and silicon nitride (Si₃N₄).

In the above structure, the insulating layer includes barium titanate (BaTiO₃) or lead titanate (PbTiO₃).

Moreover, the present invention includes in its category a light-emitting device having the aforementioned light-emitting element. The light-emitting device in this specification includes in its category an image display device, a light-emitting device, and a light source (including an illumination apparatus). Further, the light-emitting device includes a module in which a connector such as an FPC (Flexible Printed Circuit), a TAB (Tape Automated Bonding) tape, or a TCP (Tape Carrier Package) is attached to a panel where the light-emitting element is formed; a module in which a printed wiring board is provided at an end of a TAB tape or an TCP; and a module in which an IC (Integrated Circuit) is directly mounted on the light-emitting device by a COG (Chip On Glass) method.

An electronic appliance using the light-emitting element of the present invention in its display portion is also included in the category of the present invention. Therefore, the electronic appliance of the present invention has a display portion, and the display portion is equipped with the aforementioned light-emitting element and a controller for controlling light emission of the light-emitting element.

The light-emitting material of the present invention has high electric conductivity. Therefore, a light-emitting element using the light-emitting material of the present invention is capable of low-voltage driving.

Since a light-emitting device of the present invention has a light-emitting element capable of low-voltage driving, the power consumption can be reduced. Further, since a driver circuit with high withstand voltage is not necessary, the light-emitting device can be manufactured at lower cost.

In addition, since an electronic appliance of the present invention has a light-emitting element capable of low-voltage driving, the power consumption can be reduced. Moreover, since a driver circuit with high withstand voltage is not necessary, the electronic appliance can be manufactured at lower cost.

### BRIEF DESCRIPTION OF DRAWINGS

In the accompanying drawings:

FIGS. 1A and 1B explain a light-emitting material of the present invention;

FIGS. 2A and 2B explain a light-emitting element of the present invention;

FIGS. 3A and 3B explain a light-emitting element of the present invention;

FIGS. 4A and 4B explain a light-emitting element of the present invention;

FIGS. 5A and 5B explain a light-emitting element of the present invention;

FIGS. 6A and 6B explain a light-emitting device of the present invention;

FIG. 7 explains a light-emitting device of the present invention;

FIGS. 8A to 8D explain electronic appliances of the present invention;

FIG. 9 explains a n electronic appliance of the present invention; and

FIG. 10 shows a light emission spectrum of a light-emitting material of Embodiment 1.

### BEST MODE FOR CARRYING OUT THE INVENTION

Embodiment modes and an embodiment of the present invention are hereinafter described in detail with reference to drawings. However, the present invention is not limited to the following description, and it is easily understood by those skilled in the art that the mode and detail can be variously changed without departing from the scope and spirit of the present invention. Therefore, the present invention is not construed as being limited to the description of the embodiment modes and embodiment hereinafter shown.

### Embodiment Mode 1

Embodiment Mode 1 will explain a light-emitting material of the present invention. A light-emitting material of the present invention includes a base material and at least three kinds of impurity elements. Each impurity element included in the light-emitting material forms a localized level in a forbidden band of the base material. It is to be noted that the localized level includes a shallow localized level and a deep localized level. In this specification, the shallow localized level indicates a level having a small energy difference from an allowed band such as a conduction band or a valence band and the deep localized level indicates a level having a large energy difference from an allowed band.

Specifically, the impurity element forming the shallow localized level is a material having an energy difference of 0.01 to 0.3 eV from the allowed band of the base material and the impurity element forming the deep localized level is a material having an energy difference of 0.3 eV or more from the allowed band of the base material. In addition, the shallow localized level includes a donor level and an acceptor level. The donor level has a small energy difference from a conduction band; on the other hand, the acceptor level has a small energy difference from a valence band.

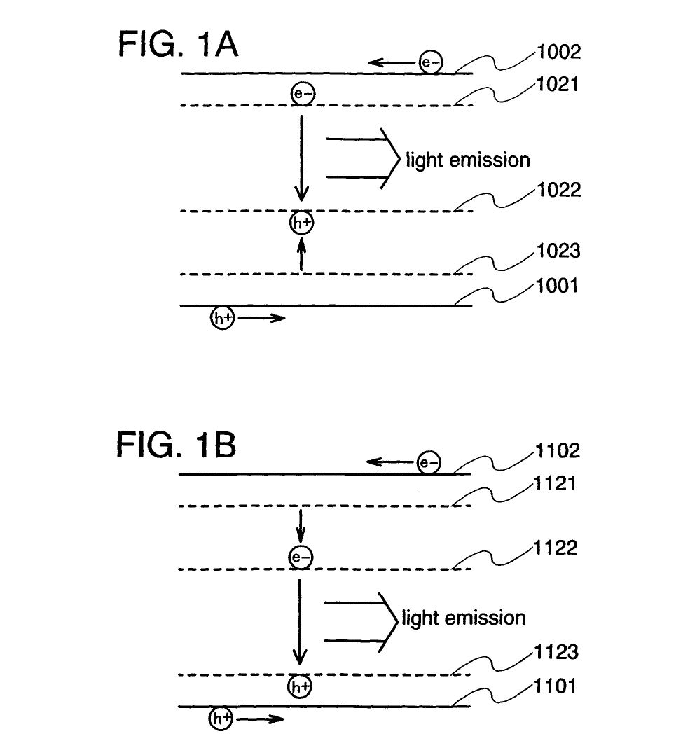

FIGS. 1A and 1B schematically show energy levels between energy bands of the light-emitting material shown in this embodiment mode. In FIG. 1A, a shallow acceptor level 1023, a shallow donor level 1021, and a deep trap level 1022 exist between a valence band 1001 and a conduction band 1002. In the light-emitting material having the energy band shown in FIG. 1A, an electron at the shallow donor level 1021 and a hole at the deep trap level 1022 recombine with each other, thereby providing light emission.

By forming the shallow acceptor level 1023 and the deep trap level 1022 in the light-emitting material, a hole transfers from the shallow acceptor level 1023 to the deep trap level 1022. The hole transferred to the deep trap level 1022 requires more energy for transferring to the adjacent site than when staying at the shallow acceptor level 1023; thus, the hole is localized at the deep trap level 1022. Therefore, recombination probability with an electron having high mobility improves, which enhances luminous efficiency.

In addition, the light-emitting material of the embodiment mode of the present invention may have an energy band such as that shown in FIG. 1B. In FIG. 1B, a shallow acceptor level 1123, a shallow donor level 1121, and a deep trap level 1122 exist between a valence band 1101 and a conduction band 1102. In a light-emitting material having the energy band shown in FIG. 1B, an electron at the deep trap level 1122 and a hole at the shallow acceptor level 1123 recombine with each other, thereby providing light emission.

By forming the shallow donor level 1121 and the deep trap level 1122 in the light-emitting material, an electron transfers from the shallow donor level 1121 to the deep trap level 1122. The electron transferred to the deep trap level 1122 requires more energy for transferring to the adjacent site than when staying at the shallow donor level 1121; thus, the electron is localized at the deep trap level 1122. Therefore, recombination probability with a hole having high mobility improves, which enhances luminous efficiency.

As the base material of the light-emitting material shown in this embodiment mode, a compound including an element of Group 2 in the periodic table and an element of Group 16 in the periodic table (hereinafter called a Group 2-16 compound) or a compound including an element of Group 12 in the periodic table and an element of Group 16 in the periodic table (hereinafter called a Group 12-16 compound) can be used.

As the Group 2-16 compound, specifically calcium sulfide (CaS), strontium sulfide (SrS), barium sulfide (BaS), or the like is given. As the Group 12-16 compound, specifically zinc sulfide (ZnS), cadmium sulfide (CdS), zinc selenide (ZnSe), zinc telluride (ZnTe), zinc oxide (ZnO), or the like is given.

As an impurity (the first impurity) for forming the shallow donor level with the Group 2-16 compound or the Group 12-16 compound used as the base material, an element of Group 17 in the periodic table can be given. Specifically, fluorine (F), chlorine (Cl), bromine (Br), iodine (I), or the like is given. Moreover, an element of Group 13 in the periodic table can be used. Specifically, boron (B), aluminum (Al), gallium (Ga), indium (In), thallium (Tl), or the like is given.

On the other hand, as an impurity (the second impurity) for forming the shallow acceptor level with the Group 2-16 compound or the Group 12-16 compound used as the base material, an element of Group 15 in the periodic table can be given. Specifically, nitrogen (N), phosphorus (P), arsenic (As), antimony (Sb), bismuth (Bi), or the like is given. Moreover, an element of Group 1 in the periodic table can be used. Specifically, lithium (Li), sodium (Na), potassium (K), rubidium (Rb), cesium (Cs), or the like is given.

As an impurity (the third impurity) for forming the deep trap level which contributes to light emission, specifically, copper (Cu), silver (Ag), gold (Au), platinum (Pt), manganese (Mn), silicon (Si), or the like is given. In addition, a rare-earth element such as terbium (Th), europium (Eu), thulium (Tm), cerium (Ce), praseodymium (Pr), or samarium (Sm) can be used.

That is to say, the light-emitting material of this embodiment mode can be formed by adding to the Group 2-16 compound or the Group 12-16 compound, an element of Group 17 or 13 as the first impurity, an element of Group 15 or 1 as the second impurity, and an impurity for forming the deep trap level which contributes to light emission as the third impurity.

The concentration of the impurity element to be added to the base material is preferably in the range of 0.01 to 10 atomic %, more preferably 0.1 to 5 atomic %, in the base material.

The light-emitting material of this embodiment mode can be formed by various methods. For example, a solid-phase reaction can be utilized. Specifically, each substance for forming the light-emitting material is weighed and mixed in a mortar; then, the mixture is heated in an electric furnace to be baked. The baking is preferably conducted at temperatures ranging from 700 to 1500° C. The baking may be conducted in a powder state but is preferably conducted in a pellet state.

In a case of using a solid-phase reaction, a compound including the first impurity and the second impurity or a compound including the first impurity and the third impurity may be used. In this case, since the first impurity and the second impurity, or the first impurity and the third impurity are easily diffused so as to promote the solid-phase reaction, a uniform light-emitting material can be obtained. Moreover, since other unnecessary impurity elements are not mixed, a light-emitting material with high purity can be obtained. As the compound including the first impurity and the second impurity, for example, an alkali halide such as lithium fluoride (LiF), lithium chloride (LiCl), lithium iodide (LiI), copper bromide (LiBr), or sodium chloride (NaCl); boron nitride (BN); aluminum nitride (AlN); aluminum antimonide (AlSb); gallium phosphide (GaP); gallium arsenide (GaAs); indium phosphide (InP); indium arsenide (InAs); indium antimonide (InSb); or the like can be used. As the compound including the first impurity and the third impurity, for example, copper fluoride (CuF₂), copper chloride (CuCl), copper iodide (Cul), copper bromide (CuBr), copper nitride (Cu₃N), copper phosphide (Cu₃P), silver fluoride (AgF), silver chloride (AgCl), silver iodide (AgI), silver bromide (AgBr), gold chloride (AuCl₃), gold bromide (AuBr₃), platinum chloride (PtCl₂), or the like can be used.

The light-emitting material in this embodiment mode has high electric conductivity because light emission by recombination of a donor-acceptor pair is obtained by the impurity element for forming the deep localized level and the impurity element for forming the shallow donor level or the shallow acceptor level, and the other impurity element that does not contribute to light emission forms a donor level or an acceptor level.

When the impurity for forming a donor level is added to the base material more than the impurity for forming an acceptor level, an n-type light-emitting material with high carrier concentration of electrons can be obtained. On the contrary, when the impurity for forming an acceptor level is added to the base material more than the impurity for forming a donor level, a p-type light-emitting material with high carrier concentration of holes can be obtained.

In addition, more than one impurity may be used to form one localized level. For example, an element of Group 15 and an element of Group 17 may be used to form a donor level. Moreover, for example, plural elements of Group 17 may be used. In a similar manner, an element of Group 1 and an element of Group 13 may be used to form an acceptor level. Further, for example, plural elements of Group 1 may be used.

Since the light-emitting material of this embodiment mode does not require a hot electron accelerated by a high electric field for light emission, the light emission is possible at low voltage.

Since the light-emitting material of this embodiment mode has high hole-electron recombination probability, the luminous efficiency is high.

### Embodiment Mode 2

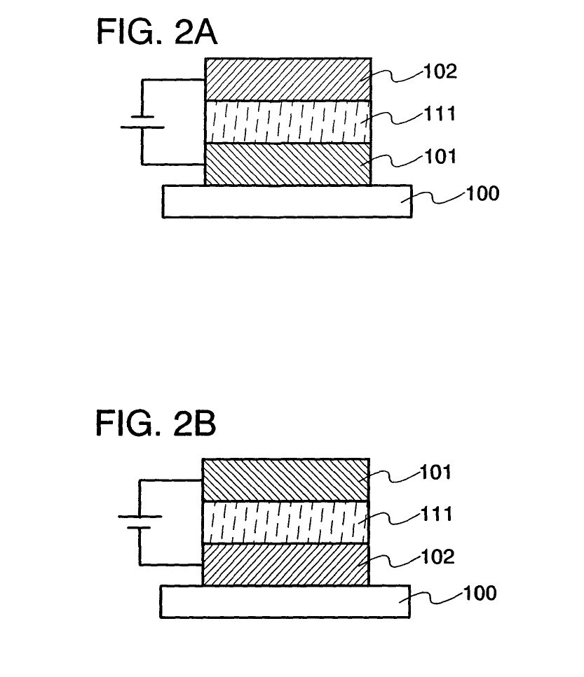

Embodiment Mode 2 will explain an aspect of a light-emitting element of the present invention with reference to FIGS. 2A and 2B.

In this embodiment mode, a light-emitting element includes a first electrode 101, a second electrode 102, and a first layer 111 interposed between the first electrode 101 and the second electrode 102. The light-emitting element shown in this embodiment mode operates by DC driving. In this embodiment mode hereinafter explained, the first electrode 101 functions as an anode and the second electrode 102 functions as a cathode.

A substrate 100 is used as a support of the light-emitting element. As the substrate 100, for example, a glass substrate, a plastic substrate, or the like can be used. Other substrates than those can also be used as long as the substrate can function as a support during a manufacturing process of the light-emitting element.

The first electrode 101 is preferably formed of a metal, alloy, conductive compound, or mixture of these, each having a high work function (specifically, 4.0 eV or more). Specifically, for example, indium oxide-tin oxide (ITO: Indium Tin Oxide), indium oxide-tin oxide including silicon or silicon oxide, indium oxide-zinc oxide (IZO: Indium Zinc Oxide), indium oxide including tungsten oxide and zinc oxide (IWZO), or the like is given. Films including these conductive metal oxides are generally formed by sputtering; however, a sol-gel method or the like may also be applied. For example, a film of indium oxide-zinc oxide (IZO) can be formed by a sputtering method using a target in which 1 to 20 wt % of zinc oxide is added to indium oxide. A film of indium oxide including tungsten oxide and zinc oxide (IWZO) can be formed by a sputtering method using a target in which 0.5 to 5 wt % of tungsten oxide and 0.1 to 1 wt % of zinc oxide are included in indium oxide. In addition, gold (Au), platinum (Pt), nickel (Ni), tungsten (W), chromium (Cr), molybdenum (Mo), iron (Fe), cobalt (Co), copper (Cu), palladium (Pd), a nitride of a metal material (such as titanium nitride (TiN)), or the like can be used. When the first electrode 101 is formed as an electrode having a light-transmitting property, even a material having low transmittance of visible light can be used by forming the material with a thickness of about 1 to 50 nm, preferably about 5 to 20 nm.

The first layer 111 is a light-emitting layer. Specifically, the first layer 111 is a layer including the light-emitting material shown in Embodiment Mode 1. The first layer 111 is preferably formed by using the light-emitting material shown in Embodiment Mode 1 formed into a thin film. However, the first layer 111 only needs to include the light-emitting material shown in Embodiment Mode 1 and its structure is not particularly limited.

The second electrode 102 can be formed of a metal, alloy, electrically conductive compound, mixture of these, or the like, each having a low work function (work function of 3.8 eV or less). As specific examples of such a cathode material, an element of Group 1 or 2 in the periodic table, i.e., an alkali metal such as lithium (Li) or cesium (Cs), an alkaline earth metal such as magnesium (Mg), calcium (Ca), or strontium (Sr), and an alloy including any of these (such as Mg:Ag or Al:Li) are given. When the second electrode 102 is formed as an electrode having a light-transmitting property, even a material having low transmittance of visible light can be used by forming the material with a thickness of about 1 to 50 nm, preferably about 5 to 20 nm.

In the light-emitting element shown in FIG. 2A, light is extracted to the outside through the first electrode 101 or the second electrode 102. Therefore, at least one of the first electrode 101 and the second electrode 102 needs to have a light-transmitting property.

For example, when the first electrode is formed of a material having a light-transmitting property, emitted light is extracted to the outside through the first electrode 101. That is, the emitted light is extracted from the substrate 100 side through the first electrode 101.

Moreover, the structure may be that the layers are stacked in the order opposite to that in the structure shown in FIG. 2A. The light-emitting element shown in FIG. 2B has a structure in which the first layer 111 and the first electrode 101 which functions as an anode are stacked in order over the second electrode 102 which functions as a cathode.

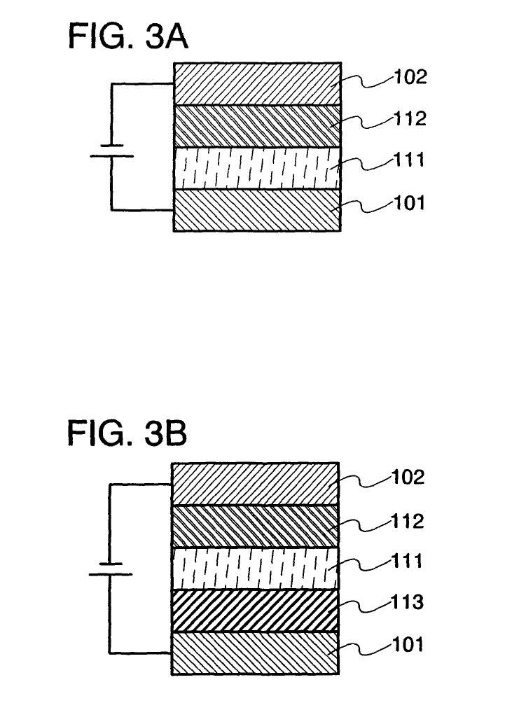

In addition, as shown in FIG. 3A, a second layer 112 which is an insulating layer may be provided between the second electrode 102 and the first layer 111. Moreover, as shown in FIG. 3B, the second layer 112 which is an insulating layer may be provided between the second electrode 102 and the first layer 111, and a third layer 113 which is an insulating layer may be provided between the first electrode 101 and the first layer 111. The insulating layers preferably have high insulation resistance, dense film quality, and a high dielectric constant. Specifically, an amorphous oxide or an amorphous nitride, such as yttrium oxide (Y₂O₃), aluminum oxide (Al₂O₃), tantalum oxide (Ta₂O₅), silicon oxide (SiO₂), or silicon nitride (Si₃N₄) can be used. In addition, a dielectric material such as barium titanate (BaTiO₃) or lead titanate (PbTiO₃) can be used. Since the light-emitting element of this embodiment mode does not require a hot electron, a high electric field is not necessary. Therefore, the insulating layers are preferably thin and the thickness thereof is preferably 500 nm or less, more preferably 100 nm or less.

By providing the insulating layer between the first layer 111 and the electrode, the luminous efficiency can be increased. Moreover, dielectric breakdown of the light-emitting element can be prevented.

The first electrode 101, the first layer 111, the second layer 112, the third layer 113, and the second electrode 102 can be formed by various methods. Specifically, a vacuum evaporation method such as a resistance heating evaporation method or an electron beam evaporation (EB evaporation) method; a physical vapor deposition (PVD) method such as a sputtering method; a chemical vapor deposition (CVD) method such as a metal organic CVD method or a low-pressure hydride transport CVD method; an atomic layer epitaxy (ALE) method; or the like can be used. In addition, an ink jet method, a spin coating method, or the like can be used. Furthermore, a different forming method may be used for each layer or each electrode.

In this embodiment mode, the light-emitting element is manufactured over a substrate made of glass, plastic, or the like. By manufacturing plural light-emitting elements over one substrate, a passive type light-emitting device can be manufactured. Moreover, the light-emitting element may be manufactured over an electrode electrically connected to, for example, a thin film transistor (TFI) formed over a substrate made of glass, plastic, or the like. Thus, an active matrix type light-emitting device which controls driving of the light-emitting element by the TFT can be manufactured. The structure of the TFT is not particularly limited. The TFT may be either of staggered type or inverted staggered type. A driver circuit formed using the TFT substrate may include both n-type and p-type TFTs. Alternatively, only one of n-type or p-type may be used. In addition, the crystallinity of a semiconductor film used for the TFT is not particularly limited. Either an amorphous semiconductor film or a crystalline semiconductor film may be used for the TFT.

The light-emitting element of the present invention provides light emission from the light-emitting layer without requiring a hot electron accelerated by a high electric field. In other words, since high voltage is not necessary to be applied to the light-emitting element, the light-emitting element can operate at low driving voltage.

Since the insulating layer, which has been used to generate hot electrons conventionally, can be made thinner or can be omitted, the proportion of voltage applied to the light-emitting layer in the total voltage applied to the entire light-emitting element increases. Therefore, a light-emitting element capable of emitting light at lower voltage can be obtained.

Since the light-emitting element can emit light at low driving voltage, the light-emitting element consumes less electric power.

It is to be noted that this embodiment mode can be appropriately combined with another embodiment mode.

### Embodiment Mode 3

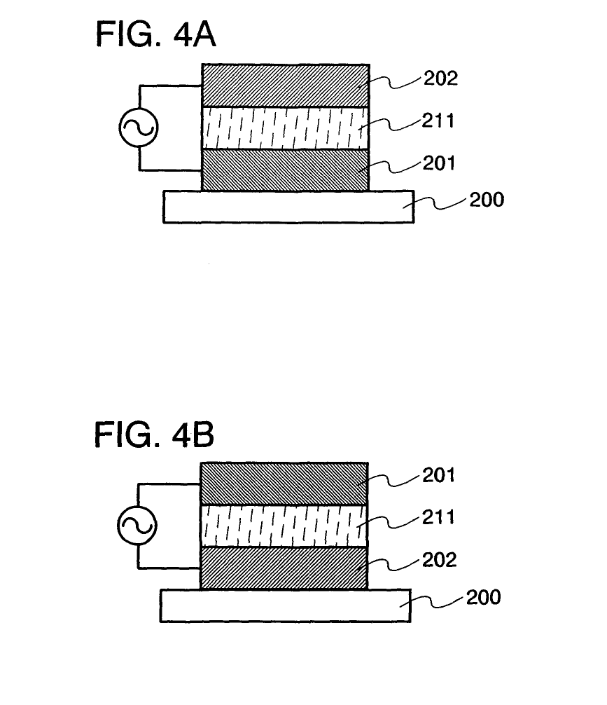

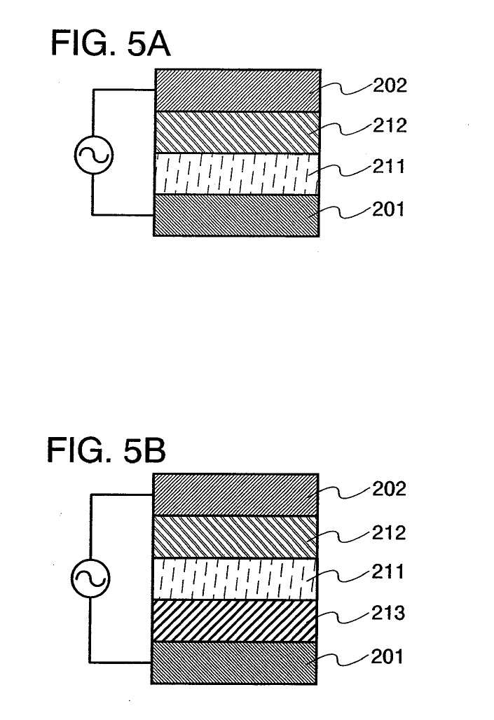

Embodiment Mode 3 will explain a light-emitting element having a different structure from that described in Embodiment Mode 2, with reference to FIGS. 4A to 5B.

In this embodiment mode, the light-emitting element has a first electrode 201, and a first layer 211, a second layer 212, a third layer 213, and a second electrode 202 which are formed over the first electrode. The light-emitting element described in this embodiment mode operates by AC driving.

A substrate 200 is used as a support of the light-emitting element. As the substrate 200, for example, a glass substrate, a plastic substrate, or the like can be used. Other substrates than these may be used as long as the substrate can function as a support during a manufacturing process of the light-emitting element.

As the first electrode 201 and the second electrode 202, various kinds of metals, alloys, and electrically conductive compounds, and a mixture of these can be used. For example, indium oxide-tin oxide (ITO: Indium Tin Oxide), indium oxide-tin oxide including silicon or silicon oxide, indium oxide-zinc oxide (IZO: Indium Zinc Oxide), indium oxide including tungsten oxide and zinc oxide (IWZO), or the like is given. Films including these conductive metal oxides are generally formed by sputtering. For example, a film of indium oxide-zinc oxide (IZO) can be formed by a sputtering method using a target in which 1 to 20 wt % of zinc oxide is added to indium oxide. A film of indium oxide including tungsten oxide and zinc oxide (IWZO) can be formed by a sputtering method using a target in which 0.5 to 5 wt % of tungsten oxide and 0.1 to 1 wt % of zinc oxide are included in indium oxide. In addition, gold (Au), platinum (Pt), nickel (Ni), tungsten (W), chromium (Cr), molybdenum (Mo), iron (Fe), cobalt (Co), titanium (Ti), copper (Cu), palladium (Pd), aluminum (Al), aluminum-silicon (Al—Si), aluminum-titanium (Al—Ti), aluminum-silicon-copper (Al—Si—Cu), a nitride of a metal material (such as titanium nitride (TiN)), or the like can be used.

In order to extract light generated from the second layer 212 to the outside, at least one of the first electrode 201 and the second electrode 202 needs to have a light-transmitting property.

For example, when the first electrode is formed of a material having a light-transmitting property, emitted light is extracted to the outside through the first electrode 201. That is, the emitted light is extracted from the substrate 200 side through the first electrode 201.

The first layer 211 is a light-emitting layer. Specifically, the first layer 211 is a layer including the light-emitting material shown in Embodiment Mode 1. The first layer 211 preferably uses the light-emitting material shown in Embodiment Mode 1 formed into a thin film. However, the first layer 211 only needs to include the light-emitting material shown in Embodiment Mode 1, and its structure is not particularly limited.

Moreover, the structure may be that the layers are stacked in the order opposite to that in the structure shown in FIG. 4A. The light-emitting element shown in FIG. 4B has a structure in which the first layer 211 and the first electrode 201 are stacked in order over the second electrode 202.

As shown in FIG. 5A, the second layer 212 which is an insulating layer may be provided between the second electrode 202 and the first layer 211. Moreover, as shown in FIG. 5B, the second layer 212 which is an insulating layer may be provided between the second electrode 202 and the first layer 211 and a third layer 213 which is an insulating layer may be provided between the first electrode 201 and the first layer 211. The insulating layers preferably have high insulation resistance, dense film quality, and a high dielectric constant. Specifically, an amorphous oxide or an amorphous nitride, such as yttrium oxide (Y₂O₃), aluminum oxide (Al₂O₃), tantalum oxide (Ta₂O₅), silicon oxide (SiO₂), or silicon nitride (Si₃N₄) can be used. In addition, a dielectric material such as barium titanate (BaTiO₃) or lead titanate (PbTiO₃) can be used. Since the light-emitting element of this embodiment mode does not require a hot electron, a high electric field is not necessary. Therefore, the insulating layers are preferably thin. The thickness thereof is preferably 500 nm or less, more preferably 100 nm or less.

By providing the insulating layer between the first layer 211 and the electrode, the luminous efficiency can be increased. Moreover, dielectric breakdown of the light-emitting element can be prevented.

The first electrode 201, the first layer 211, the second layer 212, the third layer 213, and the second electrode 202 can be formed by various methods. Specifically, a vacuum evaporation method such as a resistance heating evaporation method or an electron beam evaporation (EB evaporation) method; a physical vapor deposition (PVD) method such as a sputtering method; a chemical vapor deposition (CVD) method such as a metal organic CVD method or a low-pressure hydride transport CVD method; an atomic layer epitaxy (ALE) method; or the like can be used. In addition, an ink jet method, a spin coating method, or the like can be used. Furthermore, a different forming method may be used for each layer or each electrode.

The light-emitting element of the present invention provides light emission from the light-emitting layer without requiring a hot electron accelerated by a high electric field. In other words, since high voltage is not necessary to be applied to the light-emitting element, the light-emitting element can operate at low driving voltage.

Since the insulating layer, which has been used to generate hot electrons conventionally, can be made thinner or can be omitted, the proportion of voltage applied to the light-emitting layer in the total voltage applied to the entire light-emitting element increases. Therefore, a light-emitting element capable of emitting light at lower voltage can be obtained.

Since the light-emitting element can emit light at low driving voltage, the light-emitting element consumes less electric power.

This embodiment mode can be appropriately combined with another embodiment mode.

### Embodiment Mode 4

Embodiment Mode 4 will explain a light-emitting device having a light-emitting element of the present invention.

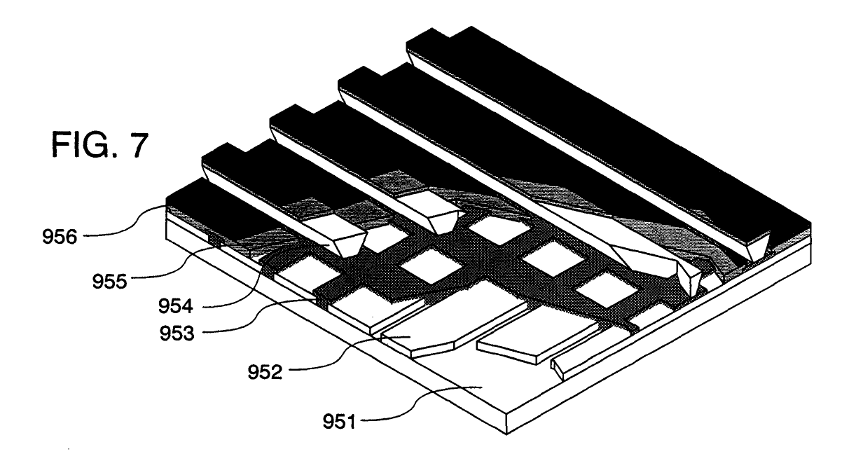

The light-emitting device shown in this embodiment mode is a passive type light-emitting device for driving a light-emitting element without particularly providing a driving element such as a transistor. FIG. 7 is a perspective view of the passive type light-emitting device manufactured by applying the present invention.

In FIG. 7, a layer 955 including a light-emitting material is provided over a substrate 951 and between an electrode 952 and an electrode 956. The layer 955 including a light-emitting material includes the light-emitting material described in Embodiment Mode 1.

End portions of the electrode 952 are covered with an insulating layer 953. Then, a partition wall layer 954 is provided over the insulating layer 953. Side walls of the partition wall layer 954 are tilted so that the distance between one side wall and the other side wall is getting shorter toward a substrate surface. That is, the cross section of the partition wall layer 954 in a short-side direction is a trapezoid with a bottom side being shorter than a top side. The bottom side is a side which extends in a direction similar to a surface direction of the insulating layer 953 and which is in contact with the insulating layer 953, and the top side is a side which extends in a direction similar to the surface direction of the insulating layer 953 and which is not in contact with the insulating layer 953. By providing the partition wall layer 954 in this manner, defects of the light-emitting element caused by static electricity or the like can be prevented. Moreover, by including the light-emitting element of the present invention that operates at low driving voltage, the passive type light-emitting device can also be driven with low power consumption.

Further, since a driver circuit with high withstand voltage is not necessary in the light-emitting device of the present invention, the light-emitting device can be manufactured at lower cost. Moreover, weight reduction of the light-emitting device and size reduction of a driver circuit portion are possible.

It is to be noted that either the structure of the light-emitting element described in Embodiment Mode 2 or that described in Embodiment Mode 3 can be applied to the light-emitting device in this embodiment mode. That is to say, the light-emitting device can be manufactured so as to operate by either DC driving or AC driving.

### Embodiment Mode 5

Embodiment Mode 5 will explain a light-emitting device having a light-emitting element of the present invention.

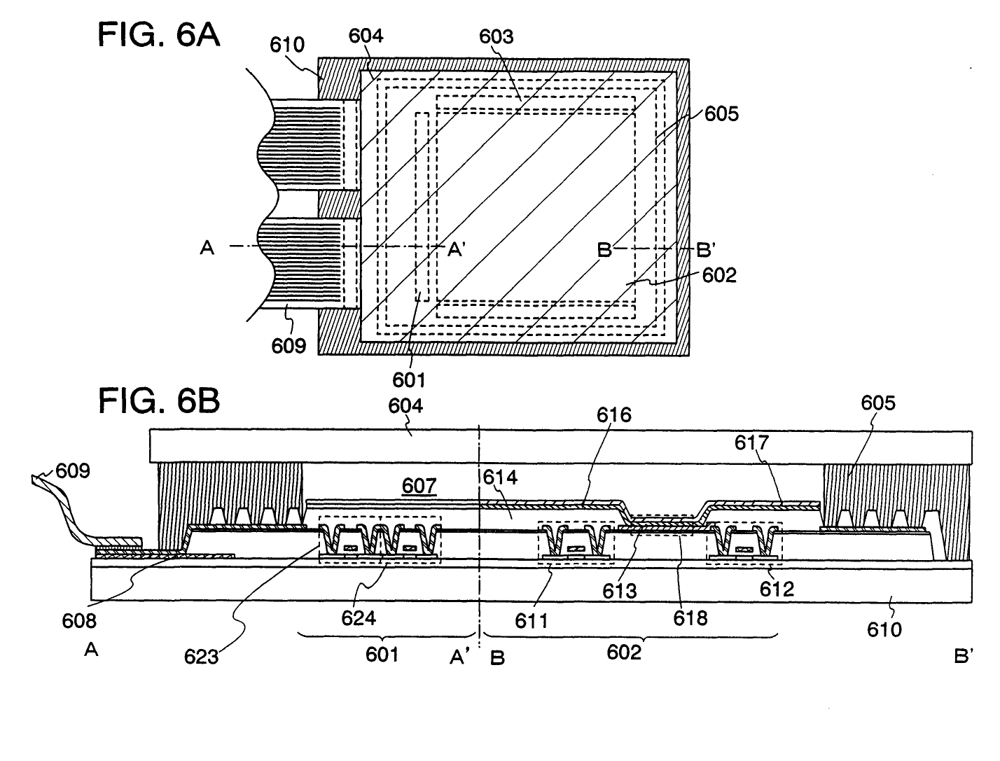

This embodiment mode will explain an active matrix type light-emitting device in which driving of a light-emitting element is controlled by a transistor. In this embodiment mode, a light-emitting device having a light-emitting element of the present invention in a pixel portion is explained with reference to FIGS. 6A and 6B. It is to be noted that FIG. 6A is a top view of the light-emitting device and FIG. 6B is a cross-sectional view along a line A-A′ and a line B-B′ of FIG. 6A Portions which are denoted by reference numerals 601, 602, and 603 and drawn with dotted lines are a driver circuit portion (source side driver circuit), a pixel portion, and a driver circuit portion (gate side driver circuit), respectively. Moreover, reference numerals 604, 605, and 607 denote a sealing substrate, a sealant, and a space surrounded by the sealant 605, respectively.

A lead wiring 608 is to transmit a signal to be inputted to the source side driver circuit 601 and the gate side driver circuit 603 and receive a video signal, a clock signal, a start signal, a reset signal, and the like from an FPC (Flexible Printed Circuit) 609 to be an external input terminal. Although only the FPC is shown here, this FPC may be provided with a printed wiring board (PWB). The light-emitting device in this specification includes not only a light-emitting device alone but also a light-emitting device provided with an FPC or a PWB.

Subsequently, a cross-sectional structure is explained with reference to FIG. 6B. The driver circuit portions and the pixel portion are formed over an element substrate 610, and specifically the source side driver circuit 601 as the driver circuit portion and one pixel in the pixel portion 602 are shown here.

In the source side driver circuit 601, a CMOS circuit is formed in which an n-channel TFT 623 and a p-channel TFT 624 are combined. A TFT included in the driver circuit may be formed by a known CMOS circuit, PMOS circuit, or NMOS circuit. Although this embodiment mode shows a driver-integrated type in which the driver circuit is formed over the substrate, the driver circuit may be formed outside the substrate instead of being formed over the substrate.

Moreover, the pixel portion 602 is formed by plural pixels including a switching TFT 611, a TFT 612, and a first electrode 613 electrically connected to a drain of the TFT 612. An insulator 614 is formed covering end portions of the first electrode 613. Here, the insulator 614 is formed by using a positive photosensitive acrylic resin film.

Moreover, an upper end portion or a lower end portion of the insulator 614 is made to have a curved surface with curvature in order to have favorable coverage. For example, in a case of using positive photosensitive acrylic as the material for the insulator 614, only the upper end portion of the insulator 614 preferably has a curved surface with a radius of curvature of 0.2 to 3 μm. As the insulator 614, either a negative type which becomes insoluble in etchant by light irradiation or a positive type which becomes soluble in etchant by light irradiation can be applied.

A layer 616 including a light-emitting material and a second electrode 617 are formed over the first electrode 613. At least one of the first electrode 613 and the second electrode 617 has a light-transmitting property; thus, light emitted from the layer 616 including a light-emitting material can be extracted to the outside.

The layer 616 including a light-emitting material includes the light-emitting material described in Embodiment Mode 1.

The first electrode 613, the layer 616 including a light-emitting material, and the second electrode 617 can be formed by various methods. Specifically, a vacuum evaporation method such as a resistance heating evaporation method or an electron beam evaporation (EB evaporation) method; a physical vapor deposition (PVD) method such as a sputtering method; a chemical vapor deposition (CVD) method such as a metal organic CVD method or a low-pressure hydride transport CVD method; an atomic layer epitaxy (ALE) method; or the like can be used. Moreover, an ink jet method, a spin coating method, or the like can be used. Furthermore, a different forming method may be used for each layer or each electrode.

Moreover, in this structure, a light-emitting element 618 is provided in the space 607 surrounded by the element substrate 610, the sealing substrate 604, and the sealant 605 by attaching the sealing substrate 604 and the element substrate 610 to each other by the sealant 605. It is to be noted that the space 607 is filled with a filling material. The filling material may be an inert gas (such as nitrogen or argon) or the sealant 605.

An epoxy-based resin is preferably used for the sealant 605. The material of the sealant 605 desirably does not transmit moisture and oxygen as much as possible. As the sealing substrate 604, a glass substrate, a quartz substrate, or a plastic substrate formed of FRP (Fiberglass-Reinforced Plastics), PVF (Polyvinyl fluoride), Mylar, polyester, acrylic, or the like can be used.

As thus described, the light-emitting device having the light-emitting element of the present invention can be obtained.

The light-emitting device of the present invention has the light-emitting element described in Embodiment Mode 2 or Embodiment Mode 3. The light-emitting element described in Embodiment Mode 2 or 3 can operate at low driving voltage and achieve high luminous efficiency. Thus, the light-emitting device consuming less electric power can be provided.

Furthermore, since the light-emitting device of the present invention does not require a driver circuit with high withstand voltage, the light-emitting device can be manufactured at lower cost. Moreover, weight reduction of the light-emitting device and size reduction of the driver circuit portion are possible.

### Embodiment Mode 6

Embodiment Mode 6 will explain electronic appliances of the present invention each including the light-emitting device shown in Embodiment Mode 5 as its part. The electronic appliance of the present invention has the light-emitting element shown in Embodiment Mode 2 or 3. Therefore, since the light-emitting element is driven at lower voltage, the electronic appliance consuming less electric power can be provided.

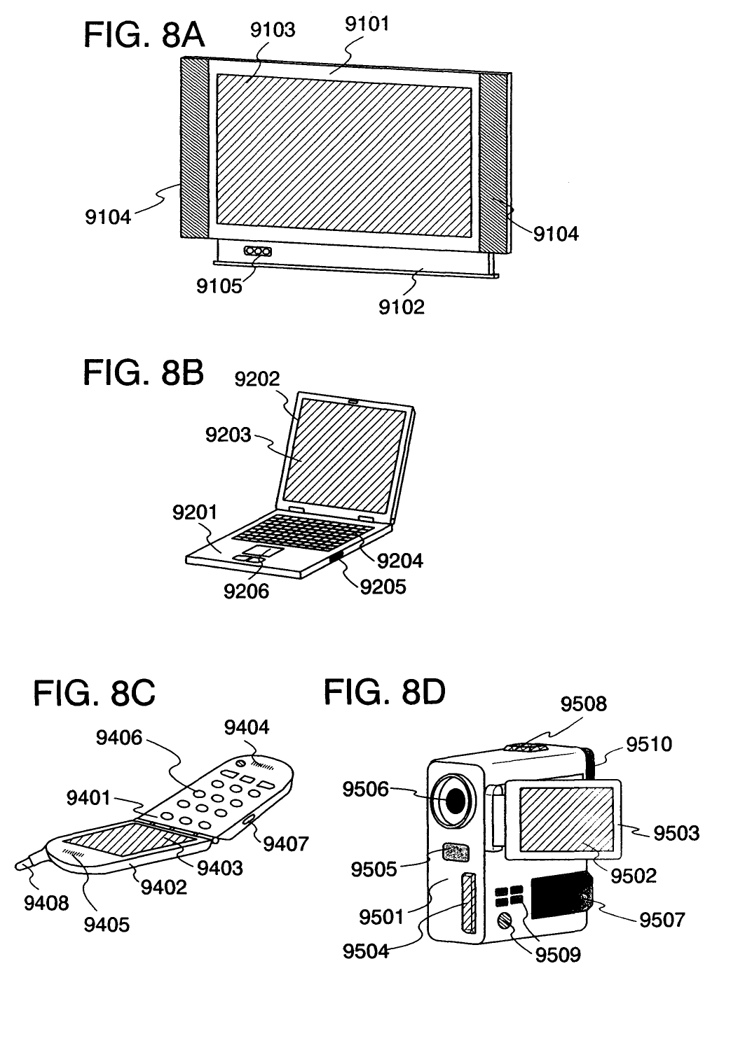

The electronic appliances manufactured using the light-emitting device of the present invention include a camera such as a video camera or a digital camera, a goggle type display, a navigation system, an audio reproducing device (such as a car audio or an audio component), a computer, a game machine, a mobile information terminal (such as a mobile computer, a mobile phone, a mobile game machine, or an electronic book), an image reproducing device equipped with a recording medium (specifically, a device which reproduces a recording medium such as a digital versatile disc (DVD) and which has a display device for displaying the image), and the like. Specific examples of these electronic appliances are shown in FIGS. 8A to 8D.

FIG. 8A shows a television device of the present invention, which includes a housing 9101, a support member 9102, a display portion 9103, speaker portions 9104, a video input terminal 9105, and the like. In this television device, the display portion 9103 has light-emitting elements similar to those described in Embodiment Modes 2 and 3 arranged in a matrix form. The light-emitting element has features of high luminous efficiency and low driving voltage. Moreover, short-circuiting by an external impact or the like can also be prevented. Since the display portion 9103 including the light-emitting element has similar features, the television device has less deterioration in image quality and consumes less electric power. With these features, the number and size of deterioration compensating circuits and power source circuits can be drastically reduced; therefore, the size and weight of the housing 9101 and the support 9102 can be reduced. Since the television device of the present invention achieves low power consumption, high image quality, and reduction in size and weight, a product suitable for a dwelling environment can be provided.

FIG. 8B shows a computer of the present invention, which includes a main body 9201, a housing 9202, a display portion 9203, a keyboard 9204, an external connection port 9205, a pointing mouse 9206, and the like. In this computer, the display portion 9203 has light-emitting elements similar to those described in Embodiment Modes 2 and 3 arranged in a matrix form. The light-emitting element has features of high luminous efficiency and low driving voltage. Moreover, short-circuiting by an external impact or the like can also be prevented. Since the display portion 9203 including the light-emitting element has similar features, the computer has less deterioration in image quality and consumes less electric power. With these features, the number and size of deterioration compensating circuits and power source circuits can be drastically reduced; therefore, the size and weight of the main body 9201 and the housing 9202 can be reduced. Since the computer of the present invention achieves low power consumption, high image quality, and reduction in size and weight, a product suitable for an environment can be provided. Moreover, the computer can be carried and the computer having the display portion which has strong resistance to an external impact when being carried can be provided.

FIG. 8C shows a mobile phone of the present invention, which includes a main body 9401, a housing 9402, a display portion 9403, an audio input portion 9404, an audio output portion 9405, an operation key 9406, an external connection port 9407, an antenna 9408, and the like. In this mobile phone, the display portion 9403 has light-emitting elements similar to those described in Embodiment Modes 2 and 3 arranged in a matrix form. The light-emitting element has features of high luminous efficiency and low driving voltage. Moreover, short-circuiting by an external impact or the like can also be prevented. Since the display portion 9403 including the light-emitting element has similar features, the mobile phone has less deterioration in image quality and consumes less electric power. With these features, the number and size of deterioration compensating circuits and power source circuits can be drastically reduced; therefore, the size and weight of the main body 9401 and the housing 9402 can be reduced. Since the mobile phone of the present invention achieves low power consumption, high image quality, and reduction in size and weight, a product superior in portability can be provided. Moreover, a product having the display portion which has strong resistance to an external impact when being carried can be provided.

FIG. 8D shows a camera of the present invention, which includes a main body 9501, a display portion 9502, a housing 9503, an external connection port 9504, a remote control receiving portion 9505, an image receiving portion 9506, a battery 9507, an audio input portion 9508, operation keys 9509, an eyepiece portion 9510, and the like. In this camera, the display portion 9502 has light-emitting elements similar to those described in Embodiment Modes 2 and 3 arranged in a matrix form. The light-emitting element has features that the luminous efficiency is high, the driving voltage is low, and short-circuiting by an external impact or the like can be prevented. Since the display portion 9502 including the light-emitting elements has similar features, the camera has less deterioration in image quality and consumes less electric power. With these features, the number and size of deterioration compensating circuits and power source circuits can be drastically reduced; therefore, the size and weight of the main body 9501 can be reduced. Since the camera of the present invention achieves low power consumption, high image quality, and reduction in size and weight, a product superior in portability can be provided. Moreover, a product having the display portion which has strong resistance to an external impact when being carried can be provided.

As thus described, the application range of the light-emitting device of the present invention is quite wide and the light-emitting device can be applied to electronic appliances of every field. By using the light-emitting device of the present invention, an electronic appliance which consumes less electric power and which has a display portion with high reliability can be provided.

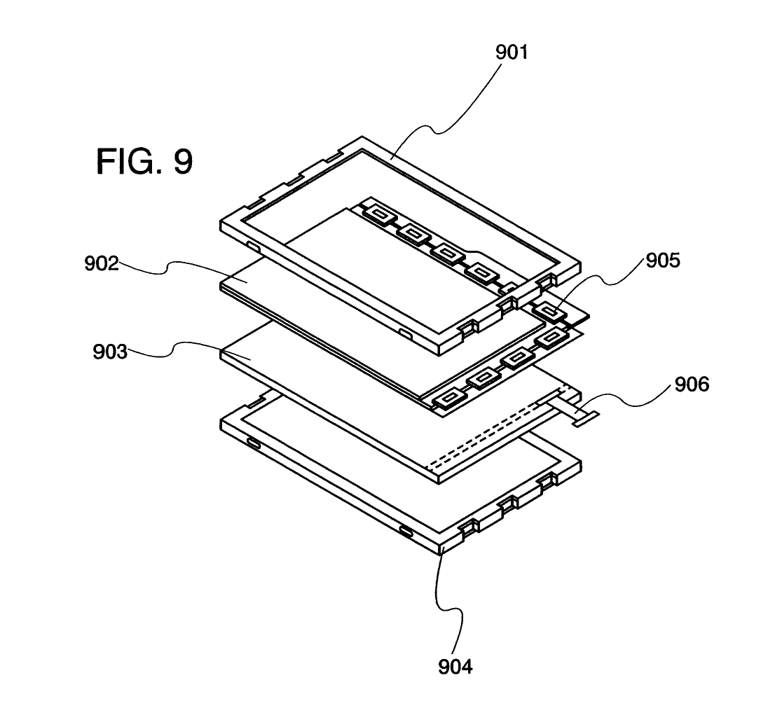

Moreover, the light-emitting device of the present invention has the light-emitting element with high luminous efficiency; therefore, the light-emitting device can also be used as an illumination apparatus. A mode of using the light-emitting device of the present invention as an illumination apparatus is explained with reference to FIG. 9.

FIG. 9 shows an example of a liquid crystal display device using the light-emitting device of the present invention as a backlight. The liquid crystal display device shown in FIG. 9 has a housing 901, a liquid crystal layer 902, a backlight 903, and a housing 904. The liquid crystal layer 902 is connected to a driver IC 905. A light-emitting device of the present invention is used as the backlight 903 to which current is supplied through a terminal 906.

By using the light-emitting device of the present invention as the backlight of the liquid crystal display device, the backlight consumes less electric power. Moreover, since the light-emitting device of the present invention is an illumination apparatus of surface light emission and can have a larger area, the backlight can also have a larger area, which enables the liquid crystal display device to have a larger area. Furthermore, since the light-emitting device is thin and consumes less electric power, the thickness and power consumption of the display device can also be reduced.

### Embodiment 1

Embodiment 1 will explain a light-emitting material of the present invention.

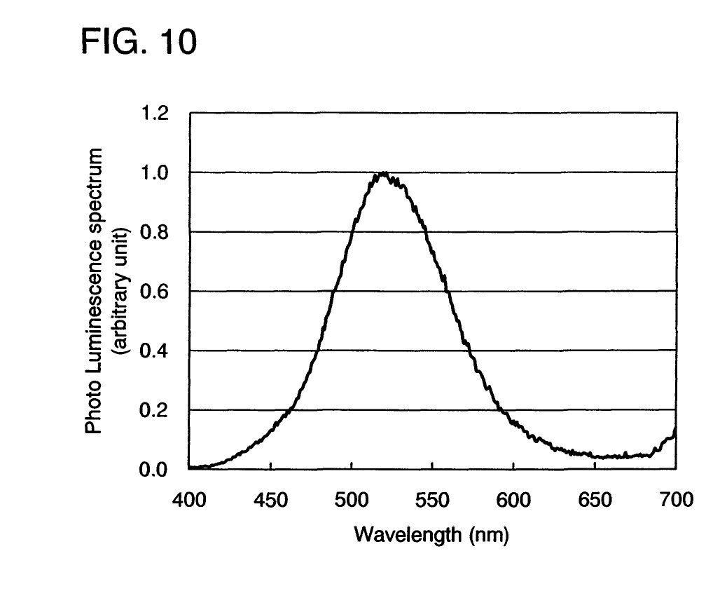

In an agate mortar, 10 g of ZnS, CuCl corresponding to 1 mol % of ZnS, and LiCl corresponding to 1 mol % of ZnS were put and stirred for ten minutes so as to be mixed. Then, the mixture was put in a crucible of alumina and baked at 1000° C. for four hours under a nitrogen atmosphere. The obtained light-emitting material was black. When the light-emitting material was excited by light with a wavelength of 356 nm, blue-green light emission was confirmed. The photo luminescence spectrum is shown in FIG. 10. It was confirmed that this light emission was caused by recombination of a donor-acceptor pair of Cl forming a donor level and Cu forming a deep trap level.

Table 1 shows a manufacturer and purity of the materials used for synthesizing the light-emitting material of this embodiment. The ZnS is manufactured by Kojundo Chemical Lab. Co., Ltd, the CuCl is manufactured by Wako Pure Chemical Industries, Ltd, and the LiCl is manufactured by Kojundo Chemical Laboratory. Co., Ltd.

TABLE 1

| material | manufacturer | purity | condition |
|---|---|---|---|
| ZnS | Kojundo Chemical | 99.999% | powder |
| | Laboratory Co., Ltd | | |
| CuCl | Wako Pure Chemical | 95.0% | powder |
| | Industries, Ltd. | | |
| LiCl | Kojundo Chemical | >99.9% | powder |
| | Laboratory Co., Ltd | | |

This application is based on Japanese Patent Application serial no. 2006-019867 filed in Japan Patent Office on Jan. 27, 2006, the entire contents of which are hereby incorporated by reference.

1. A light-emitting material comprising:
a base material;
a first impurity for forming a shallow donor level in the base material;
a second impurity for forming a shallow acceptor level in the base material; and
a third impurity for forming a deep trap level between the shallow donor level and the shallow acceptor level,
wherein the base material comprises a compound comprising a first element of Group 16 in the periodic table and at least a second element selected from the group consisting of elements of Group 2 and Group 12 in the periodic table.

2. The light-emitting material according to claim 1, wherein light is emitted by recombination of an electron at the shallow donor level and a hole at the deep trap level.

3. The light-emitting material according to claim 1, wherein light is emitted by recombination of an electron at the deep trap level and a hole at the shallow acceptor level.

4. The light-emitting material according to claim 1, wherein an energy difference between the shallow donor level and a conduction band of the base material is in the range of 0.1 eV to 0.3 eV.

5. The light-emitting material according to claim 1, wherein an energy difference between the shallow acceptor level and a valence band of the base material is in the range of 0.1 eV to 0.3 eV.

6. The light-emitting material according to claim 1, wherein an energy difference between the deep trap level and each of a conduction band and a valence band is in the range of 0.3 eV or more.

7. The light-emitting material according to claim 1, wherein the second element is an element of Group 2 in the periodic table.

8. The light-emitting material according to claim 1, wherein the second element is an element of Group 12 in the periodic table.

9. The light-emitting material according to claim 1, wherein the compound is one selected from the group consisting of calcium sulfide, strontium sulfide, barium sulfide zinc sulfide, cadmium sulfide, zinc selenide, zinc telluride, and zinc oxide.

10. The light-emitting material according to claim 1, wherein the first impurity is an element of Group 17 in the periodic table or Group 13 in the periodic table.

11. The light-emitting material according to claim 1, wherein the second impurity is an element of Group 15 in the periodic table or Group 1 in the periodic table.

12. The light-emitting material according to claim 1, wherein the third impurity is one selected from the group consisting of copper, silver, gold, platinum, manganese, silicon, terbium, europium, thulium, cerium, praseodymium, and samarium.

13. A light-emitting device comprising:
a first electrode;
a second electrode; and
a light-emitting layer formed between the first electrode and the second electrode,
wherein the light-emitting layer comprises a base material, a first impurity for forming a shallow donor level in the base material, a second impurity for forming a shallow acceptor level in the base material, and a third impurity for forming a deep trap level between the shallow donor level and the shallow acceptor level, and
wherein the base material comprises a compound comprising a first element of Group 16 in the periodic table and at least a second element selected from the group consisting of elements of Group 2 and Group 12 in the periodic table.

14. The light-emitting device according to claim 13, wherein light is emitted by recombination of an electron at the shallow donor level and a hole at the deep trap level.

15. The light-emitting device according to claim 13, wherein light is emitted by recombination of an electron at the deep trap level and a hole at the shallow acceptor level.

16. The light-emitting device according to claim 13, wherein an energy difference between the shallow donor level and a conduction band of the base material is in the range of 0.1 eV to 0.3 eV.

17. The light-emitting device according to claim 13, wherein an energy difference between the shallow acceptor level and a valence band of the base material is in the range of 0.1 eV to 0.3 eV.

18. The light-emitting device according to claim 13, wherein an energy difference between the deep trap level and each of a conduction band and a valence band is in the range of 0.3 eV or more.

19. The light-emitting device according to claim 13, wherein the second element is an element of Group 2 in the periodic table.

20. The light-emitting device according to claim 13, wherein the second element is an element of Group 12 in the periodic table.

21. The light-emitting device according to claim 13, wherein the compound is one selected from the group consisting of calcium sulfide, strontium sulfide, barium sulfide zinc sulfide, cadmium sulfide, zinc selenide, zinc telluride, and zinc oxide.

22. The light-emitting device according to claim 13, wherein the first impurity is an element of Group 17 in the periodic table or Group 13 in the periodic table.

23. The light-emitting device according to claim 13, wherein the second impurity is an element of Group 15 in the periodic table or Group 1 in the periodic table.

24. The light-emitting device according to claim 13, wherein the third impurity is one selected from the group consisting of copper, silver, gold, platinum, manganese, silicon, terbium, europium, thulium, cerium, praseodymium, and samarium.

25. An electronic appliance comprising the light-emitting device of claim 13.

26. A light-emitting device comprising:
a first electrode;
a second electrode;
a light-emitting layer formed between the first electrode and the second electrode,
a insulating layer formed between the light-emitting layer and one of the first and second electrodes
wherein the light-emitting layer comprises a base material, a first impurity for forming a shallow donor level in the base material, a second impurity for forming a shallow acceptor level in the base material, and a third impurity for forming a deep trap level between the shallow donor level and the shallow acceptor level, and
wherein the base material comprises a compound comprising a first element of Group 16 in the periodic table and at least a second element selected from the group consisting of elements of Group 2 and Group 12 in the periodic table.

27. The light-emitting device according to claim 26 further comprising an insulating layer formed between the light emitting layer and one of the first and second electrodes.

28. The light-emitting device according to claim 26, wherein the insulating layer has a thickness in the range of 1 nm to 500 nm.

29. The light-emitting device according to claim 28, wherein the insulating layer has a thickness in the range of 1 nm to 100 nm.

30. The light-emitting device according to claim 26, wherein the insulating layer comprises at least one of yttrium oxide, aluminum oxide, tantalum oxide, silicon oxide, and silicon nitride, barium titanate and lead titanate.

31. An electronic appliance comprising the light-emitting device of claim 26.
